(19) United States
(12) Patent Application Publication
(10) Pub. No.: US 2006/0205433 A1
(43) Pub. Date: Sep. 14, 2006

(54) Method and apparatus for receiving signals using diversity in wireless network

(75) Inventors: Dae-Hyun Sim, Seoul (KR); Jhae-Kon Jhun, Anyang-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/367,524

(22) Filed: Mar. 3, 2006

(30) Foreign Application Priority Data
Mar. 8, 2005 (KR) 2005-19206

(51) Int. Cl. H04B 7/00; H04M 1/00

(52) U.S. Cl. 455/552.1; 455/41.2

(57) ABSTRACT

Disclosed is a mobile station for receiving signals by means of diversity in a wireless network, which includes a mobile communication radio signal reception unit for receiving mobile communication radio signals; a local area communication unit for communicating with another mobile station located near the mobile station; a signal processor for processing received signals by means of signals received through the mobile communication radio signal reception unit and the local area communication unit; and a controller for forming a Local Area Network (LAN) with said another mobile station by means of the local area communication unit, transmitting the mobile communication radio signals to said another mobile station through the LAN, receiving via the local area communication unit the mobile communication radio signals, and forwarding the received mobile communication radio signals to the signal processor.

### PRIORITY

This application claims priority to an application entitled “Method and Apparatus for receiving Signals using Diversity in Wireless Network” filed in the Korean Intellectual Property Office on Mar. 8, 2005 and assigned Serial No. 2005-19206, the contents of which are incorporated herein by reference.

### BACKGROUND OF THE INVENTION

1. Field of the Invention

The present invention relates to a reception signal processing technology in a wireless network such as a mobile communication network, and more particularly to a method and an apparatus for receiving signals by means of diversity.

2. Description of the Related Art

Wireless channel environments in a mobile communication system are subject to distortion of actual transmission signals due to various factors such as multi-path interference, shadowing, wave attenuation, time-varying noise and interference.

Fading due to the multi-path interference is closely related to the mobility of a reflector or a user, i.e., a user terminal. Accordingly, the actual transmission signals are mixed with interference signals and the mixed signals are received by a receiver. Because this fading may distort the amplitude and phase of the received signals, it may become a main factor disturbing high speed data communications in the wireless channel environments. Therefore, extensive research is being conducted in order to solve the fading problem. As a result, in order to transmit data at high speeds in a mobile communication system, it is necessary to minimize loss and user interference due to the characteristics of a mobile communication channel.

A multi-antenna diversity scheme has emerged as an effective method to correct the fading problem. According to the multi-antenna diversity scheme, a plurality of transmission signals having experienced independent fading in wireless channel environments are received, and distortion due to the fading is overcome. The multi-antenna diversity scheme may employ various schemes such as frequency diversity schemes, multi-path diversity schemes and space diversity schemes.

The frequency diversity scheme is a diversity scheme for simultaneously using two or more frequencies, in which fading characteristics are independent, because frequencies have different propagation characteristics. According to the frequency diversity scheme using different frequencies, the different frequencies provide different states for fading and reduce the probabilities that the worst reception outputs of the two frequencies simultaneously occur. Therefore, the frequency diversity scheme can reduce the influence of fading.

The space diversity scheme is a scheme for acquiring diversity using two or more antennas. According to the space diversity scheme, when signals transmitted through one antenna are attenuated by fading, signals transmitted through the other antennas are received in order to acquire a diversity gain. The space diversity scheme may be classified into a receive antenna diversity scheme including a plurality of receive antennas, a transmit antenna diversity scheme including a plurality of transmit antennas, and a Multiple Input Multiple Output (MIMO) scheme including a plurality of receive antennas and a plurality of transmit antennas.

When the diversity scheme using such a multi-antenna system is used, the physical size of an antenna array may be a main problem. That is, when two or more antennas are installed in a portable terminal for multi-antenna diversity, it is difficult to set a minimum interval between antennas to a quarter-wavelength (λ/4) for 800, 1900, 2100 MHz. For example, an antenna interval of about 1 m or 4˜5 m may also be required. When considering this point, the minimum interval between antennas is not effective for apparatuses such as cellular phones and laptop computers. It is possible to install a multi-antenna in one portable terminal ignoring the minimum interval between antennas, but a distance between antennas is not sufficiently ensured, so that it is impossible to acquire efficient space diversity. Moreover, it is difficult to manufacture a portable terminal capable of handling power consumption caused by two reception paths.

### SUMMARY OF THE INVENTION

Accordingly, the present invention has been made to solve at least the above-mentioned problems occurring in the prior art, and it is an object of the present invention to provide a method and an apparatus for receiving signals by means of diversity in a wireless network capable of satisfying a minimum interval between antennas in a portable terminal.

It is another object of the present invention to provide a method and an apparatus for receiving signals by means of diversity in a wireless network for allowing a portable terminal having a Single-Input Single-Output (SISO) antenna to obtain antenna diversity.

In order to accomplish the aforementioned object, according to one aspect of the present, there is provided a mobile station for receiving signals by means of diversity in a wireless network, the mobile station includes a mobile communication radio signal reception unit for receiving mobile communication radio signals; a local area communication unit for communicating with another mobile station located near the mobile station; a signal processor for processing received signals by means of signals received through the mobile communication radio signal reception unit and the local area communication unit; and a controller for forming a Local Area Network (LAN) with said another mobile station by means of the local area communication unit, transmitting the mobile communication radio signals to said another mobile station through the LAN, receiving via the local area communication unit the mobile communication radio signals, and forwarding the received mobile communication radio signals to the signal processor.

In order to accomplish the aforementioned object, according to another aspect of the present, there is provided a method for receiving signals by means of diversity in a wireless network, the method includes performing local area wireless communication for an adjacent sub-mobile station through a local area wireless communication operation when a main mobile station is in a radio signal reception mode; transmitting a diversity function request message to the sub-mobile station through the local area wireless communication application and receiving permission signals in response to the diversity function request message; transmitting information of the sub-mobile station to a currently connected base station transceiver system; transmitting to the sub-mobile station and the main mobile station, by the base station transceiver system connected to the main mobile station data, when the diversity function request message is received from the main mobile station; transmitting by the sub-mobile station the received data of the main mobile station to the main mobile station through the local area wireless communication operation; and processing by the main mobile station received signals by means of the radio signals received from the base station transceiver system and the sub-mobile station.

In order to accomplish the aforementioned object, according to further another aspect of the present, there is provided an operation method of a mobile station for receiving signals by means of diversity in a wireless network, the method includes connecting to a sub-mobile station through WLAN during a radio signal reception mode and establishing an ad-hoc communication mode with the sub-mobile station; to the sub-mobile station through the WLAN, transmitting information for reception signal processing, which includes a carrier frequency, Auto Gain Control (AGC) level information, Voltage controlled & Temperature Compensated Crystal Oscillator (VCTCXO) voltage information, and allowing the sub-mobile station to receive and transmit radio signals according to the corresponding transmitted information; and performing a reception signal processing operation by means of the radio signals transmitted from the sub-mobile station and radio signals received in the mobile station.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a mobile communication system to which the present invention is applied;

FIG. 2 is a block diagram illustrating the construction of a mobile station according to the characteristics of the present invention, which employs a signal reception function using diversity;

FIG. 3 is a block diagram illustrating the construction of main elements in a mobile station according to one embodiment of the present invention, which employs a signal reception function using diversity;

FIG. 4 is a ladder diagram illustrating a main process for receiving signals by means of diversity in a mobile communication system according to one embodiment of the present invention;

FIG. 5 is a block diagram illustrating the construction of main elements in a mobile station according to another embodiment of the present invention, which employs a signal reception function using diversity; and

FIG. 6 is a flow diagram illustrating a signal reception operation using diversity in a mobile station according to another embodiment of the present invention.

### DETAILED DESCRIPTION OF THE PREFERRED EMBODIMENT

Hereinafter, preferred embodiments according to the present invention will be described with reference to the accompanying drawings. In the below description, many particular items, such as detailed elements, are shown, but these are provided for helping the general understanding of the present invention, it is apparent to those skilled in the art that the particular items can be modified or varied within the scope of the present invention.

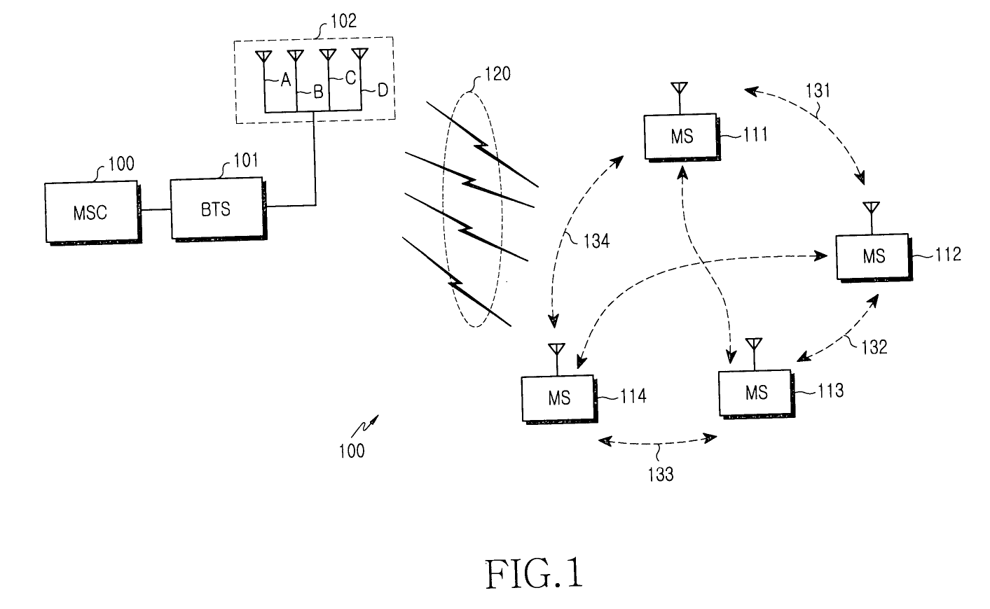

FIG. 1 is a block diagram illustrating the construction of a mobile communication system to which the present invention is applied. According to the characteristics of the present invention, the mobile communication system 100, including a Local Area Network (LAN) or a Mobile Ad-Hoc Network (MANET) and a Wide Area Network (WAN), has been disclosed. Referring to FIG. 1, the mobile communication system 100 includes a plurality of Base Station Transceiver Systems (BTSs) 101, and a Mobile Switching Center (MSC) 100 for operating and managing plural BTSs, etc. The BTSs 101 communicate with portable terminals 111 to 114, i.e., Mobile Stations (MSs), located in a corresponding service area, and provide services to the MSs 111 to 114. Reference numbers 131 to 134 marked by dotted lines represent radio frequency links of an LAN or a MANET between the MSs 111 to 114.

The BTS 101 can transmit not only voice signals but also digital data to the MSs 111 to 114 according to an IEEE 802.16, an IEEE 802.20, a CDMA 2000, a 1× EV-DV, a 1× EV-DO or similar standards in an embodiment of the present invention. Herein, the BTS 101 has a charge zone with a radius of 1 to 3 km. The BTS 101 transmits data to the MSs 111 to 114 through a downlink channel 120 at a data rate of 600 Kbps to 2 Mbps. In order to exchange data with the MSs 111 to 114 in the embodiment of the present invention, the BTS 101 may use a conventional Multi-Input Multi-Output (IMO) antenna system 102. The antenna system 102 includes four antenna elements marked by A, B, C and D.

Each of the MSs 111 to 114 is a terminal (e.g., a cellular phone, an IEEE 802.11 device, etc.) for performing local area communication therebetween by means of Bluetooth, etc., or operating in an Ad-Hoc node. Each of the MSs 111 to 114 uses a general Single-Input Single-Output (SISO) antenna system in order to receive data from the BTS 101 and transmit data to the BTS 101. According to the present invention, these MSs 111 to 114 form an LAN or a MANET, which provides each MS with virtual antenna diversity and an MIMO antenna system, thereby acquiring gain from signals transmitted from the BTS 101.

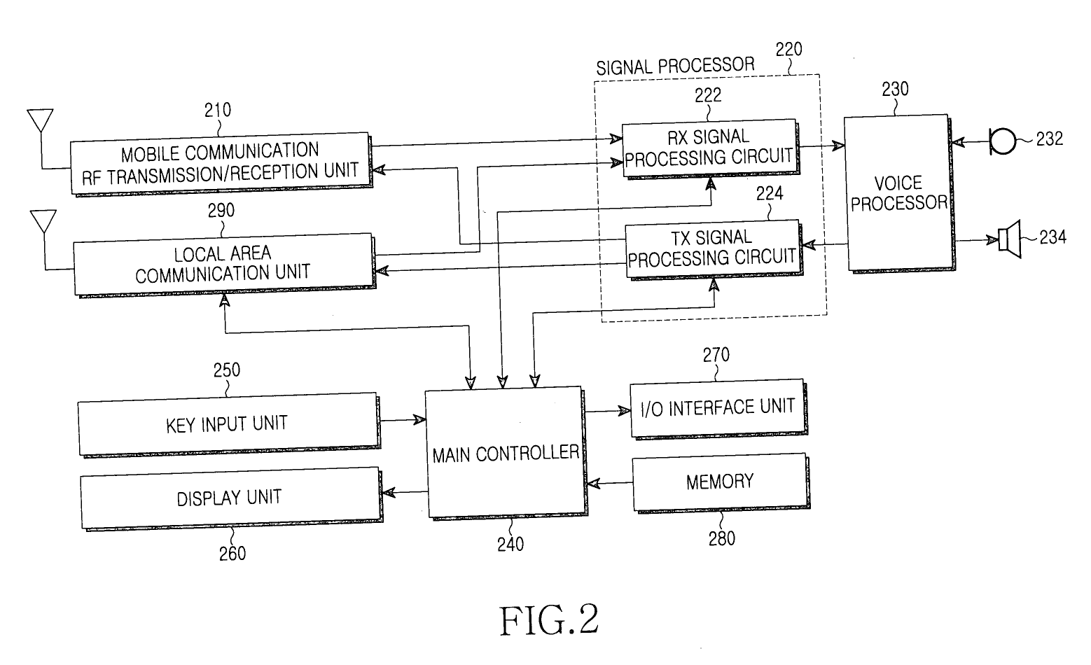

FIG. 2 is a block diagram illustrating the construction of an MS according to the present invention, which employs a signal reception function using diversity. Referring to FIG. 2, the MS includes a mobile communication Radio Frequency (RF) transmission/reception unit 210, a signal processor 220 comprised of a transmit (TX) signal processing circuit 224 and a receive (RX) signal processing circuit 222, a voice processor 230, a main controller 240, an Input/Output (I/O) interface unit 270, a key input unit 250, a display unit 260, a memory 280 and a local area communication unit 290.

The MS according to the embodiment of the present invention as illustrated in FIG. 2 includes two transmission/reception units, i.e., the mobile communication RF transmission/reception unit 210 and the local area communication unit 290. For example, the MS uses the mobile communication RF transmission/reception unit 210 when performing long distance communication with a BTS according to a CDMA 2000 standard, an IEEE 802.16 standard, etc. Further, the MS uses the local area communication unit 290 when another MS performs local area communication according to a Bluetooth standard or an IEEE 802.11 standard. It is noted that two transceivers are presented for description, but it should not be considered to limit the scope of the present invention. The technical core lies in that the MS not only can perform communication with a BTS of a wireless network but can also directly perform communication with other MSs.

Further, the MS includes two antennas employed in the mobile communication RF transmission/reception unit 210 and the local area communication unit 290. However, these two antennas may either be constructed as one integrated antenna or have a construction for separating signal bands by hardware such as a duplexer.

The mobile communication RF transmission/reception unit 210 receives radio signals transmitted from the BTS and down-converts the received radio signals in order to generate Intermediate Frequency (IF) or baseband signals. The IF or baseband signals are sent to the receive signal processing circuit 222 of the signal processor 220. The receive signal processing circuit 222 digitizes, decodes or filters the baseband or IF signals, and transmits the corresponding processed signals (e.g., voice data) to the voice processor 230 or the main controller 240 for further processing (e.g., web browsing). The voice processor 230 converts the signals provided from the receive signal processing circuit 222 to analog signals, and outputs the analog signals through a speaker 234 as audible sounds. In addition, the voice processor 230 digitizes voice signals input through a microphone 232 and provides the digital voice signals to the transmit signal processing circuit 224 of the signal processor 220.

The transmit signal processing circuit 224 receives the digital voice signals output from the voice processor 230 and the baseband data (e.g., web data, video game data) output from the main controller 240, encodes and multiplexes the received digital voice signals and baseband data, and provides the processed signals to the mobile communication RF transmission/reception unit 210. The memory 280 includes a ROM, an EEPROM, an RAM, etc., and stores various operation programs of the MS and information required for operation performance.

The main controller 240 controls the general operations of the MS according to the operation programs stored in the memory 280. That is, the main controller 240 controls a reception rate of a downlink channel and transmission of uplink channel signals through the mobile communication RF transmission/reception unit 210 and the signal processor 220, as is well known in the art. Further, the main controller 240 connects to the I/O interface unit 270. The I/O interface unit 270 is a communication path between peripheral devices and the main controller 240, which may allow the MS to be connected to other apparatuses such as laptop computers. Further, the main controller 240 connects to the key input unit 250 and the display unit 260. The key input unit 250 includes a plurality of number keys and function keys for performing various functions, and outputs electrical signals of key data generated by key input of a user to the main controller 240. The display unit 260 may include a Liquid Crystal Display (LCD), and displays texts or images according to performance of various operations of the MS under the control of the main controller 240.

For example, the local area communication unit 290 in the MS performs local area communication for another MS located near the MS according to a Bluetooth standard or an IEEE 802.11 standard. The main controller 240 connects to said another MS by means of the local area communication unit 290, causes said another MS to receive mobile communication radio signals of the MS, and causes said another MS to transmit the received signals through an LAN. The signals transmitted from said another MS through the LAN are provided to the signal processor 220. The signal processor 220 processes the corresponding signals in order to obtain antenna diversity.

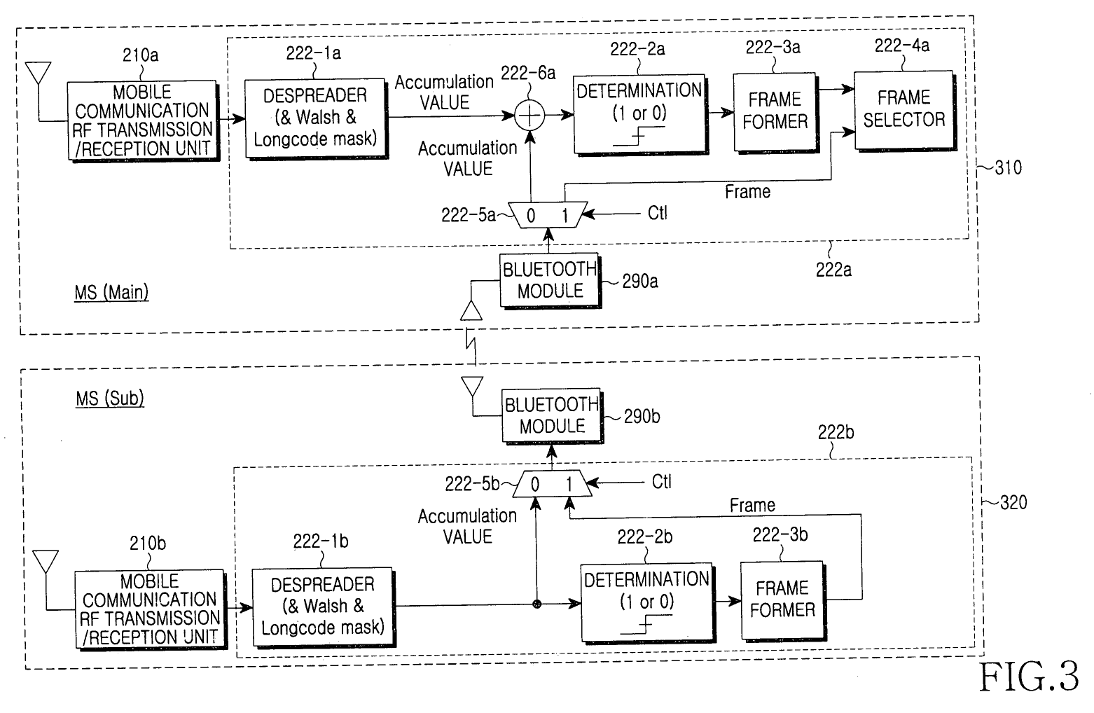

FIG. 3 is a block diagram illustrating the construction of the main elements in the MS according to one embodiment of the present invention, which employs the signal reception function using diversity. FIG. 3 shows the construction using a Bluetooth communication network. For convenience of description, FIG. 3 shows two MSs, i.e., a main MS 310 and a sub-MS 320. Further, FIG. 3 shows only the construction required when the sub-MS 320 receives and processes mobile communication radio signals of the main MS 310, and transmits the processed signals to the main MS 310 through the Bluetooth communication network, and the main MS 310 processes the signals transmitted from the sub-MS 320. However, it goes without saying that each of the two MSs 310 and 320 has all constructions of the other MS.

Referring to FIG. 3, in the main MS 310, the signal processor 222a includes a despreader 222-1a, a demultiplexer 222-5a, an adder 222-6a, a determination unit 222-2a, a frame former 222-3a and a frame selector 222-4a. The despreader 222-1a despreads the baseband signals provided from the mobile communication RF transmission/reception unit 210a, and outputs an accumulated value for data of one bit, and the demultiplexer 222-5a demultiplexes an accumulated value for data of one bit or a frame provided from the sub-MS 320 through a Bluetooth module 290a according to control signals Ctl. The adder 222-6a adds the accumulated value for the data of one bit output from the despreader 222-1a to the accumulated value for the data of one bit provided from the sub-MS 320 through the demultiplexer 222-5a. The determination unit 222-2a determines if a data bit is ‘1’ or ‘0’ from the output of the adder 222-6a, and the frame former 222-3a forms a frame through the output of the determination unit 222-2a. Further, the frame selector 222-4a selects a more available frame between the frame provided from the sub-MS 320 through the demultiplexer 222-5a and the frame provided from the frame former 222-3a.

In the sub-MS 320, the signal processor 222b includes all constructions of the signal processor 222a in the main MS 310. In addition, the signal processor 222b includes a multiplexer 222-5b for multiplexing an accumulated value for data of one bit or a frame output from a despreader 222-1b and a frame former 222-3b according to control signals Ctl. The output of the multiplexer 222-5b in the sub-MS 320 is transmitted to the main MS 310 through a Bluetooth module 290b. Further, it is noted that the demultiplexer 222-5a in the main MS 310 has the same construction as that of the multiplexer 222-5b in the sub-MS 320.

When a BTS transmits data to the MSs 310 and 320, the BTS must transmit the data, which is to be retransmitted to the main MS 310, to the sub-MS 320 as well as the main MS 310. The main MS 310 adds the accumulated value for the data of one bit obtained through the receive path of the main MS 310 to the accumulated value for the data of one bit obtained through the receive path of the sub-MS 320 via the high speed LAN, and uses a result of the addition when determining if the received data bit is 1 or 0. Further, the frame selector 222-4a compares the frame data obtained through the receive path of the main MS 310 with the frame data obtained through the receive path of the sub-MS 320 via the high speed LAN, so that more available frames can be acquired. This improvement effect in a Bit Error Rate (BER) of the reception unit according to the characteristic construction of the present invention is similar to a result using general frequency and space diversity.

In the meantime, it is necessary to perform a process for synchronization between the main MS 310 and the sub-MS 320 in the MS having the construction as described above. This may be classified into a case in which the adder 222-4a adds the accumulated values for the data of one bit and the determination unit 222-2a determines if the data bit is 1 or 0, and a case in which the frame selector 222-4a selects a frame through comparison of frames, for description, as illustrated in FIG. 3. In the former case, Pseudo random Noise (PN) synchronization may be used. For example, the main MS 310 and the sub-MS 320 may be connected to the same BTS. That is, it may be considered that the PN 1 of a BTS “A” is connected to the main MS 310 and the PN 2 of the BTS “A” is connected to the sub-MS 320. In this case, because the data is simultaneously transmitted from one point by means of each PN, and the main MS 310 and the sub-MS 320 are spaced a very small interval apart from each other as compared with a PN one chip delay, there is a small difference between a PN1 delay between the BTS “A” and the main MS 310 and a PN2 delay between the BTS “A” and the sub-MS 320. Accordingly, whether the previously received data bit is 1 or 0 is determined by means of the previously obtained accumulated values during accumulation of values to be used for determining if a currently received data bit is 1 or 0. For example, when a PN rate is 1.2288 Mcps, a PN one chip delay is 244.14 meters. When a data rate is 9.6 Kbps, 128 PN chips exist in one data.

Next, in the latter case, frame synchronization may be used. For example, the MSs may be connected to different BTSs. That is, it may be considered that the main MS 310 is connected to a BTS “A” and the sub-MS 320 is connected to a BTS “B”. In this case, the same data is transmitted from a MSC to the BTSs “A” and “B” at the same point in time and the data arrives at the main MS 310 and the sub-MS 320 via each BTS because a data delay difference may occur due to the difference in distance between the MSC and each BTS and the difference in distance between each BTS and each MS, the MSC inserts frame numbers of circular number type into each frame when transmitting the data. Accordingly, the frame selector 222-4a compares the frames in which the corresponding frame numbers coincide with each other, thereby selecting a more available frame.

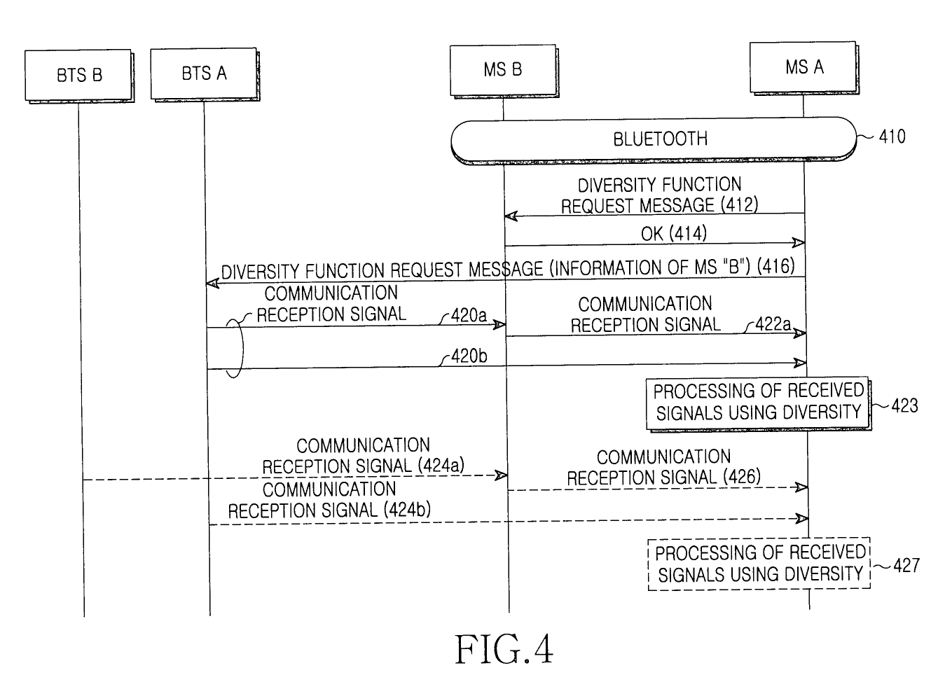

FIG. 4 is a ladder diagram illustrating a main process for receiving signals by means of diversity in a mobile communication system according to one embodiment of the present invention. For example, FIG. 4 shows an operation when a main MS “A” is in a radio signal reception mode for voice communication, etc., through a BTS “A”. Referring to FIG. 4, in step 410, the main MS “A” is connected to adjacent sub-MS(s) “B” by Bluetooth in the radio signal reception mode. In step 412, the main MS “A” transmits a properly preset diversity function request message according to the characteristics of the present invention. In step 414, a sub-MS “B” transmits permission signals “OK” in response to the diversity function request message. In step 416, the main MS “A” transmits a diversity function request message to the BTS “A” together with information of the sub-MS “B” connected by Bluetooth. In steps 420a and 420b, the BTS “A” transmits data, which needs to be retransmitted to the main MS “A”, to the sub-MS “B” as well as the main MS “A”. In step 422a, the sub-MS “B” computes an accumulated value for data of one bit of the signals received in step 420, and transmits a message in a properly preset format to the main MS “A”. In step 423, the main MS “A” adds an accumulated value for data of one bit, which has been computed by the main MS “A”, to the accumulated value for the data of one bit obtained through the receive path of the sub-MS “B”, and uses a result of the addition when determining if the received data bit is 1 or 0.

Further, processes marked by the dotted lines in FIG. 4 show for a case where the two MSs “A” and “B” are connected to different BTSs “A” and “B”, respectively. The diversity function request message of the main MS “A” is transmitted to an MSC via the BTS “A” in step 416. The MSC transmits the same data to the BTSs “A” and “B”. The data is transmitted to the sub-MS “B” and the main MS “A” via the BTSs “A” and “B” in steps 424a and 424b. In step 426, the sub-MS “B” transmits frame data obtained by processing the received data to the main MS “A”. As a result, in step 427, the main MS “A” compares data obtained through a receive path in the main MS “A” with the frame data from the sub-MS “B”, thereby acquiring a more available frame.

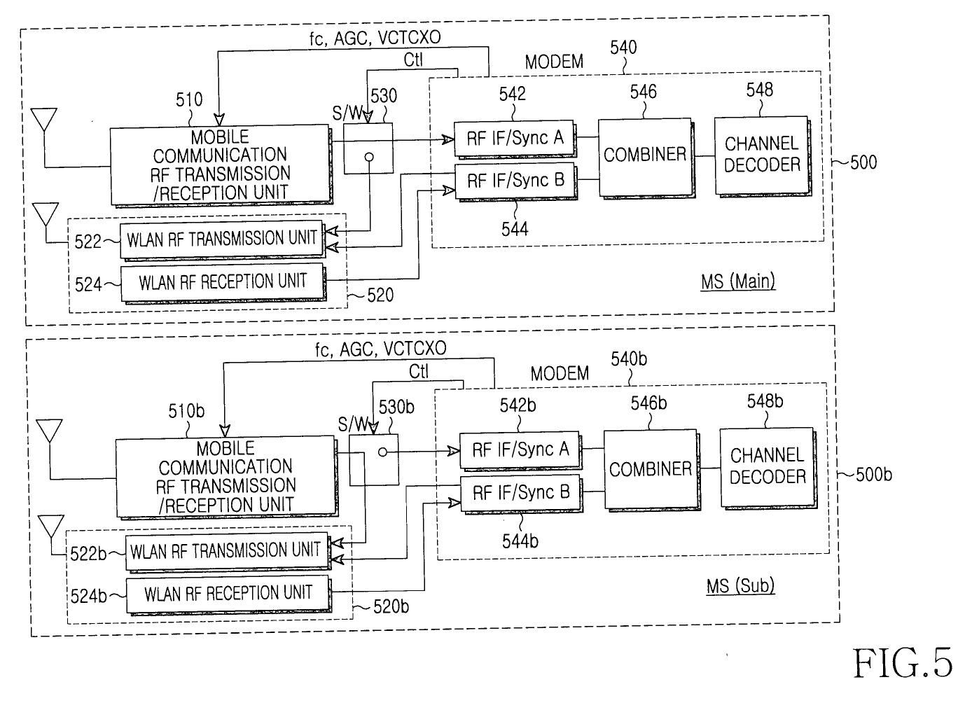

FIG. 5 is a block diagram illustrating the construction of main elements in an MS according to another embodiment of the present invention, which employs a signal reception function using diversity. FIG. 5 shows the construction using a Wireless LAN (WLAN). The construction of FIG. 5 is a construction for achieving antenna diversity by using a reception unit in common under the permission of another MS by means of a WLAN ad-hoc connectivity mode. For convenience of description, FIG. 5 shows two MSs, i.e., a main MS 500 and a sub-MS 500b. It is noted that the hardware construction of the two MSs 500 and 500b are equal to each other.

Referring to FIG. 5, the two MSs 500 and 500b include WLAN transmission/reception units 520 and 520b, respectively. Further, modems 540 and 540b as signal processors must include signal processors for diversity reception or MIMO demodulation. Furthermore, the MSs 500 and 500b include switches (or multiplexers) 530 and 530b for receiving signals for controlling a radio signal path through a WLAN and performing a path setup based on the received signals, respectively.

The WLAN transmission/reception unit 520 of the MS 500 includes a WLAN transmission unit 522 and a WLAN reception unit 524 and the WLAN transmission/reception unit 520b of the MS 500b includes a WLAN transmission unit 522b and a WLAN reception unit 524b. The main MS 500 sends proper control signals (carrier frequency setup, AGC parameter, VCTCXO control voltage) to the reception unit of the sub-MS 500b (adjacent terminal, at a distance of more than λ/4) through the WLAN by means of the WLAN transmission/reception unit 520. Then, the sub-MS 500b transmits radio signals received in a mobile communication radio signal reception unit 510b to the main MS 500 through the WLAN by means of a switch 530b and the WLAN transmission/reception unit 520b. The modem 540 of the main MS 500 includes demodulators 542 and 544, a combiner 546, a channel decoder 548, etc. The demodulators 542 and 544 receive radio signals received in the main MS 500 and the radio signals transmitted from the sub-MS 500b through the WLAN transmission/reception unit 520b, respectively, and demodulate the received radio signals into IF and baseband signals. The combiner 546 performs soft-combining or MIMO decoding for signals output from the demodulators 542 and 544, and the channel decoder 548 performs channel decoding for signals output from the combiner 546.

The main MS 500 must receive the approval of an adjacent terminal (another selectable terminal) for use of the reception unit through the WLAN. In this approval process, information for frequency/transmit power/receive power, etc., of the WLAN must be exchanged and stabilized. After this approval, a parameter of the main MS 500 is transmitted to the sub-MS 500b for the common use of the radio signal reception unit. The parameter includes a carrier frequency, Auto Gain Control (AGC) level information, Voltage controlled & Temperature Compensated Crystal Oscillator (VCTCXO) voltage information, etc. This information is initialization information transmitted from the main MS 500. The main MS 500 continuously updates the information through a WLAN transmission channel. This update process is a typical WLAN operation, i.e., a Request To Send/Clear To Send/DATA/Acquisition (RTS/CTS/DATA/ACQ) process. Herein, WLAN communication must be stipulated in order to achieve an optimized update rate, i.e., an update rate having a gain maximized through receive diversity. Further, in order to use a conventional 2.5 G/3 G (2.5 generation/3rd generation) controller in common, the transmitted update information (carrier frequency, AGC level information, VCTCXO voltage information) must be designed to be controlled by a register and multiplexer (switch) or at least switch. For maximization of gain, it is preferred to fix the distance between the two MSs and the locations of the two MSs. Further, a gyro-sensor, etc., may be use in order to update location information (distance between antennas, angles of antennas).

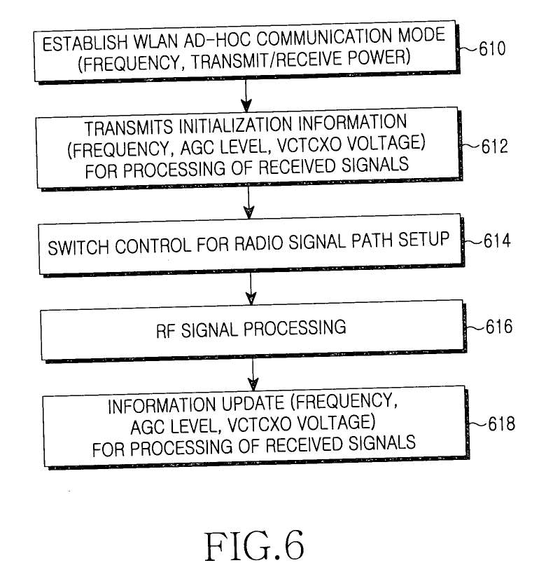

FIG. 6 is a flow diagram illustrating a signal reception operation using diversity in the MS (i.e., the main MS) according to another embodiment of the present invention. FIG. 6 shows an operation when the main MS is in a radio signal reception mode for voice communication, etc. Referring to FIG. 6, in step 610, the MS establishes a WLAN ad-hoc communication mode with adjacent MSs. In step 612, the MS transmits initialization information (carrier frequency, AGC level, VCTCXO voltage) for the processing of the received signals to the adjacent MSs having established the communication mode. Accordingly, the adjacent sub-MSs perform the radio signal reception operation based on the corresponding transmitted information. In step 614, the MS performs a switch control operation for a radio signal path setup. As illustrated in FIG. 5, the main MS 500 performs a path switching control of the switch 530 so that the signals received in the mobile communication radio signal reception unit 510 can be provided to the modem via the switch 530. Further, the sub-MS 500b performs a path switching control so that the signals received in the mobile communication radio signal reception unit 510b can be provided to the WLAN transmission/reception unit 520b via the switch 530b. Accordingly, the radio signals received in the sub-MS 500b are transmitted to the main MS 500, and the main MS 500 performs a processing operation for the received radio signals in step 616. Then, in step 618, the main MS 500 performs an information update operation for processing of the received radio signals.

As described above, signal reception technology using diversity in a wireless network according to the present invention can satisfy an antenna mutual coupling in an MS. In particular, the technology can cause an MS having an SISO antenna to acquire antenna diversity.

While the present invention has been shown and described with reference to certain preferred embodiments thereof, it will be understood by those skilled in the art that various changes in form and details may be made therein without departing from the spirit and scope of the present invention as defined by the appended claims. For example, in the above description, a scheme for achieving diversity of the present invention has been described through the constructions and operations of one main MS and one sub-MS. However, it is possible to allow the main MS to achieve diversity by means of a plurality of sub-MSs. Further, in the above description, Bluetooth or WLAN is used for local area communication between MSs. However, it is also possible to use a Beam-forming Network (BFN).

What is claimed is:

1. A mobile station for receiving signals by means of diversity in a wireless network, the mobile station comprising:
a mobile communication radio signal reception unit for receiving mobile communication radio signals;
a local area communication unit for communicating with another mobile station located near the mobile station;
a signal processor for processing received signals by means of signals received through the mobile communication radio signal reception unit and the local area communication unit; and
a controller for forming a Local Area Network (LAN) with said another mobile station by means of the local area communication unit, transmitting the mobile communication radio signals to said another mobile station through the LAN, receiving via the local area communication unit the mobile communication radio signals, and forwarding the received mobile communication radio signals to the signal processor.

2. The mobile station as claimed in claim 1, wherein the local area communication unit transmits signals via Bluetooth or Wireless LAN (WLAN).

3. The mobile station as claimed in claim 1, wherein the signal processor comprises:
a despreader for dispreading baseband signals provided from the mobile communication radio signal reception unit and outputting an accumulated value for data of one bit;
a demultiplexer for demultiplexing an accumulated value for data of one bit or a frame provided from said another mobile station through the local area communication unit according to control signals;
an adder for adding the accumulated value for the data of one bit output from the despreader to the accumulated value for the data of one bit provided from said another mobile station through the demultiplexer;
a determination unit for determining a data bit value output from the adder;
a frame former for forming a frame from the output of the determination unit; and
a frame selector for selecting a frame from between the frame provided from said another mobile station through the demultiplexer and the frame, which is provided from the frame former, according to a preset scheme.

4. The mobile station as claimed in claim 1, further comprising a switch for performing a path setup in order to transmit the signals received in the mobile communication radio signal reception unit to the signal processor or the local area communication unit,
wherein the signal processor comprises:
at least two demodulators for receiving the radio signals received in the mobile station and the radio signals transmitted from said another mobile station through the local area communication unit, and for demodulating the received radio signals into IF and baseband signals;
a combiner for performing soft-combining or MIMO decoding for signals output from the at least two demodulators; and
a channel decoder for performing channel decoding for signals output from the combiner,
wherein the controller transmits to said another mobile station through the local area communication unit information for processing the received signals, which includes a carrier frequency, Auto Gain Control (AGC) level information, Voltage controlled & Temperature Compensated Crystal Oscillator (VCTCXO) voltage information, and controls said another mobile station to operate based on the information.

5. A method for receiving signals by means of diversity in a wireless network, the method comprising the steps of:
performing local area wireless communication for an adjacent sub-mobile station through a local area wireless communication operation when a main mobile station is in a radio signal reception mode;
transmitting a diversity function request message to the sub-mobile station through the local area wireless communication operation and receiving permission signals in response to the diversity function request message;
transmitting information of the sub-mobile station to a currently connected base station transceiver system;
transmitting to the sub-mobile station and the main mobile station by the base station transceiver system connected to the main mobile station, data that is to be retransmitted to the main mobile station, when the diversity function request message is received from the main mobile station;
transmitting by the sub-mobile station the received data of the main mobile station to the main mobile station through the local area wireless communication operation; and
processing by the main mobile station received signals by means of the radio signals received from the base station transceiver system and the sub-mobile station.

6. The method as claimed in claim 5, wherein the predetermined local area communication operations include Bluetooth or Wireless LAN (WLAN).

7. The method as claimed in claim 5, wherein the sub-mobile station transmits an accumulated value for data of one bit of the received signals or frame data when the sub-mobile station transmits the received data of the main mobile station to the main mobile station through the local area wireless communication operation.

8. An operation method of a mobile station for receiving signals by means of diversity in a wireless network, the method comprising the steps of:
connecting to a sub-mobile station through WLAN during a radio signal reception mode and establishing an ad-hoc communication mode with the sub-mobile station;
transmitting to the sub-mobile station through the WLAN, information for a reception signal processing, which includes a carrier frequency, Auto Gain Control (AGC) level information, Voltage controlled & Temperature Compensated Crystal Oscillator (VCTCXO) voltage information, and allowing the sub-mobile station to receive and transmit radio signals according to the corresponding transmitted information; and
performing a reception signal processing operation by means of the radio signals transmitted from the sub-mobile station and radio signals received in the mobile station.

9. The method as claimed in claim 8, further comprising a step of continuously transmitting the information for the reception signal processing to the mobile station for update.
